(19) United States
(12) Patent Application Publication
(10) Pub. No.: US 2009/0238110 A1
(43) Pub. Date: Sep. 24, 2009

(54) Base Station Apparatus and Method for Controlling Base Station Apparatus

(75) Inventor: Masaharu Suzuki, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/295,703

(22) PCT Filed: Apr. 3, 2007
(86) PCT No.: PCT/JP2007/057451

§ 371 Date: Jan. 22, 2009

(30) Foreign Application Priority Data
Apr. 3, 2006 (JP) 2006-101394

(51) Int. Cl. H04W 4/00

(52) U.S. Cl. 370/328

(57) ABSTRACT

In a base station apparatus (12), a timing information calculating part (22) calculates timing information indicating a timing when each transmission buffer (40) becomes empty. A packet flow control part (26) selects at least one transmission buffer (40) based on each piece of the timing information calculated by the timing information calculating part (22), and controls a packet flow, in a transmission path, directed to a mobile station apparatus associated with the selected transmission buffer.

### TECHNICAL FIELD

The present invention relates to a base station apparatus and a method for controlling a base station apparatus, and more particularly, to a base station apparatus for which data transmission rates in a wired section and a wireless section vary dynamically and a method for controlling a base station apparatus.

### BACKGROUND ART

A base station apparatus in a mobile communication system such as a cell-phone system or a personal handy-phone system (PHS) is connected to a mobile station apparatus via a wireless transmission path, and is also connected to another base station apparatus via a line switching network such as an integrated services digital network (ISDN) or via a wired transmission path such as an Internet protocol (IP) network. The base station apparatus converts packets received via the wired transmission path into radio signals, and then transmits the radio signals to a specified mobile station apparatus. Further, the base station apparatus receives radio signals transmitted from the mobile station apparatus and converts the radio signals into packets, which are then transmitted to a specified base station apparatus via the wired transmission path.

In general, a transmission rate in a wired transmission path is higher than a transmission rate in a wireless transmission path in many cases. In order to reduce such a difference in transmission rates, as illustrated in FIG. 5, the base station apparatus is provided, for each radio resource (radio slot for time division multiple access system or the like), with a transmission buffer that temporarily accumulates packets received via the wired transmission path. The base station apparatus accumulates the packets in the transmission buffer until the transmission buffer becomes full, and then, when the transmission buffer has become likely to overflow, controls a packet flow in the wired transmission path until the packets accumulated in the transmission buffer become less than a predetermined amount, thereby adjusting the aforementioned difference in transmission rates.

On the other hand, as illustrated in FIG. 6, when data transmission directed to a mobile station apparatus A has been completed or when transmission data directed to the mobile station apparatus A has reached a predetermined amount, packet supply from the wired transmission path is stopped, and a transmission buffer A associated with the mobile station apparatus A becomes empty. Then, as illustrated in FIG. 7, the mobile station apparatus A shifts to a communication waiting state (is queued in Wait queue), allowing the radio resource (radio slot A) associated with the transmission buffer A to be allocated to another mobile station apparatus E that has been in the communication waiting state (queued in normal Ready queue).

In Patent Document 1 described below, there is disclosed a technology in which, in a mobile communication system, based on a round-trip propagation delay time from a time at which a control signal is sent out to a data transfer control apparatus to a time at which data transferred from the radio network control apparatus is received and a transfer rate for transferring the data to a mobile terminal device, a data transfer volume from the radio network control apparatus is controlled, thereby improving the throughput of data transmission. According to this technology, when an accumulated volume of data in a radio base station apparatus has exceeded a predetermined volume, data transfer from the radio network control apparatus is suspended, whereas, when the accumulated volume of data has fallen below the predetermined volume, the data transfer can be resumed.

Patent Document 1: JP 2004-200886 A

### DISCLOSURE OF THE INVENTION

### Problems to be Solved by the Invention

As illustrated in FIG. 8, however, in such a situation where a wired transmission path with a limited transmission rate is shared for packet communications involving a plurality of mobile communications, from time to time, the transmission rate in the wired transmission path becomes lower than the transmission rates of the wireless transmission paths. In such a case, according to the aforementioned conventional mobile communication system, once a transmission buffer becomes empty temporarily, a radio resource associated with the transmission buffer is allocated to another mobile station apparatus even if the communication is continuing. Because data communication cannot be performed while the allocation of the radio resource is changed, if such allocation change of the radio resource is repeated frequently until the transmission rate in the wired transmission path exceeds the transmission rate of the radio resource, the throughput of the data transmission declines dramatically.

In view of the aforementioned problem with the prior art, the present invention has been made, and therefore has an object to provide a base station apparatus that reduces the frequency of allocation change of a radio resource by preventing a transmission buffer from becoming empty during communication and can thereby improve the throughput of data transmission and a method for controlling a base station apparatus.

### Means for Solving the Problems

In order to achieve the aforementioned object, according to the present invention, a base station apparatus that is configured to: receive, in communicating with each of a plurality of mobile station apparatuses via a wireless channel, packets directed to each of the mobile station apparatuses, which are transmitted from another base station apparatus connected via a transmission path; accumulate the received packets in each transmission buffer in association with each of the mobile station apparatuses; and sequentially transmit the packets accumulated in the each transmission buffer to each of the mobile station apparatuses, includes: timing information calculating means for calculating timing information indicating a timing when the each transmission buffer becomes empty; and packet flow control means for selecting at least one transmission buffer based on each piece of the timing information calculated by the timing information calculating means, and controlling, in the transmission path, a packet flow directed to the mobile station apparatus associated with the selected transmission buffer.

Further, according to the present invention, a method for controlling a base station apparatus that is configured to: receive, in communicating with each of a plurality of mobile station apparatuses via a wireless channel, packets directed to each of the mobile station apparatuses, which are transmitted from another base station apparatus connected via a transmission path; accumulate the received packets in each transmission buffer in association with each of the mobile station apparatuses; and sequentially transmit the packets accumulated in the each transmission buffer to each of the mobile station apparatuses, includes: a timing information calculating step of calculating timing information indicating a timing when the each transmission buffer becomes empty; and a packet flow control step of selecting at least one transmission buffer based on each piece of the timing information calculated in the timing information calculating step, and controlling, in the transmission path, a packet flow directed to the mobile station apparatus associated with the selected transmission buffer.

According to the present invention, the base station apparatus calculates the timing information indicating the timing when the each transmission buffer becomes empty. Then, the base station apparatus selects at least one transmission buffer based on the calculated each piece of the timing information, and controls, in the transmission path, the packet flow directed to the mobile station apparatus associated with the selected transmission buffer. According to the present invention, it is possible to select the transmission buffer that becomes empty at earlier timing and to accelerate the packet flow directed to the mobile station apparatus associated with the transmission buffer. Alternatively, it is possible to select the transmission buffer that becomes empty at later timing and to limit the packet flow directed to the mobile station apparatus associated with the transmission buffer. With this configuration, the transmission buffer can be prevented from becoming empty, and the frequency of allocation change of a radio resource is reduced, thereby enabling the throughput of data transmission to be improved.

Further, according to an aspect of the present invention, the timing information calculating means includes accumulated data amount acquiring means for acquiring, for each of the mobile station apparatuses, a data amount of the packets accumulated in the each transmission buffer, and calculates the timing information based on the data amount acquired by the accumulated data amount acquiring means and a rate of change of the data amount. With this configuration, it is possible to calculate the timing when the transmission buffer becomes empty based on the data amount of the packets accumulated in the transmission buffer and the rate of change thereof.

Further, according to an aspect of the present invention, the timing information calculating means further includes: wireless transmission rate acquiring means for acquiring a transmission rate of the packets in the wireless channel with respect to each of the mobile station apparatuses; and transmission path reception rate acquiring means for acquiring a transmission rate of the packets in the transmission path with respect to each of the mobile station apparatuses. The rate of change of the data amount is calculated based on the transmission rate acquired by the wireless transmission rate acquiring means and the transmission rate acquired by the transmission path reception rate acquiring means. With this configuration, it is possible to calculate the timing when the transmission buffer becomes empty based on the data amount of the packets accumulated in the transmission buffer, the transmission rate in the wireless channel, and the transmission rate in the transmission path.

According to an aspect of the present invention, the packet flow control means selects at least one transmission buffer with the timing information equal to or larger than a predetermined value, and limits, in the transmission path, the packet flow directed to the mobile station apparatus associated with the selected transmission buffer. With this configuration, it is possible to limit the packet flow directed to the mobile station apparatus associated with the transmission buffer that is expected to become empty at later timing, thereby enabling the timing when another transmission buffer becomes empty to be delayed.

According to an aspect of the present invention, the packet flow control means selects the transmission buffer with the timing information indicating a largest value, and limits, in the transmission path, the packet flow directed to the mobile station apparatus associated with the selected transmission buffer. With this configuration, it is possible to limit the packet flow directed to the mobile station apparatus associated with the transmission buffer that is expected to become empty at the latest timing, thereby enabling the timing when another transmission buffer becomes empty to be delayed.

According to an aspect of the present invention, the packet flow control means cancels a limitation on the packet flow when the data amount with respect to at least one transmission buffer other than the selected transmission buffer, which is acquired by the accumulated data amount acquiring means, has become equal to or larger than a predetermined amount. With this configuration, when the data amount within the transmission buffer with the timing of becoming empty being delayed reaches an adequate amount, it is possible to cancel the limitation on the packet flow and to restore the packet flow to the former state.

### BRIEF DESCRIPTION OF THE DRAWINGS

FIG. 1 is a configuration diagram of a mobile communication system according to an embodiment of the present invention.

FIG. 2 is a functional block diagram of a base station apparatus according to the embodiment of the present invention.

FIG. 3 is a diagram illustrating a process of adjusting an amount of packets accumulated in a transmission buffer by limiting a packet flow in a wired transmission path.

FIG. 4 is a flow chart illustrating a process of controlling the packet flow.

FIG. 5 is a diagram illustrating a relation between transmission rates in wireless channels and transmission rates in the wired transmission path and data amounts of packets accumulated in the transmission buffers.

FIG. 6 is a diagram illustrating a case where packet supply from the wired transmission path is suspended and a transmission buffer has become empty.

FIG. 7 is a diagram illustrating a process of allocating a radio slot, for which the transmission buffer has become empty, to a mobile station apparatus waiting for communication.

FIG. 8 is a diagram illustrating a case where the transmission rates in the wired transmission path are below the transmission rates in the wireless transmission paths.

### BEST MODE FOR CARRYING OUT THE INVENTION

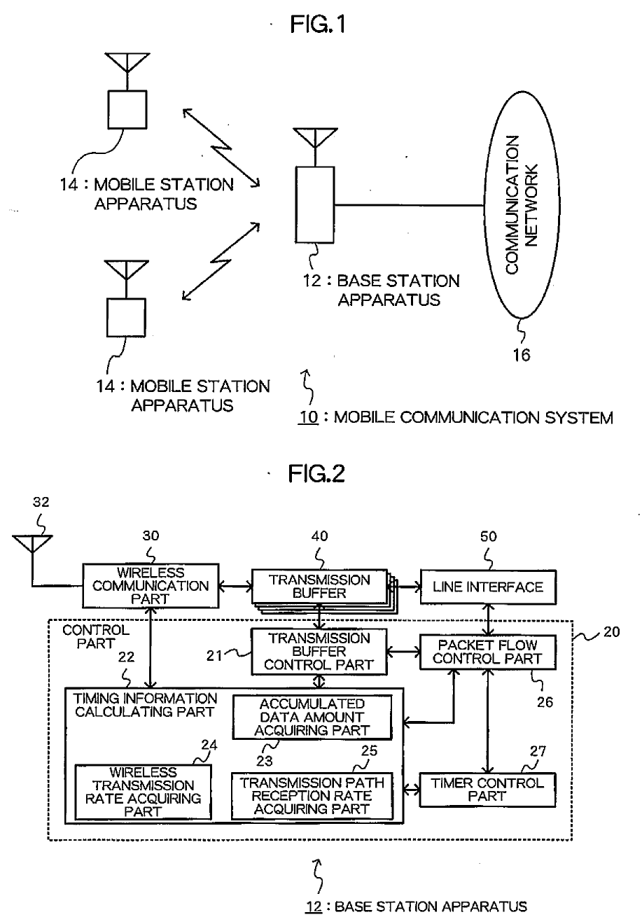

Herein below, an embodiment according to the present invention is described with reference to the drawings. FIG. 1 is a diagram illustrating an overall configuration of a mobile communication system 10 according to the embodiment of the present invention. As illustrated in FIG. 1, the mobile communication system 10 includes a base station apparatus 12 connected to a communication network 16 via a wired transmission path and a plurality of mobile station apparatuses 14 each connected to the base station apparatus 12 via a wireless transmission path.

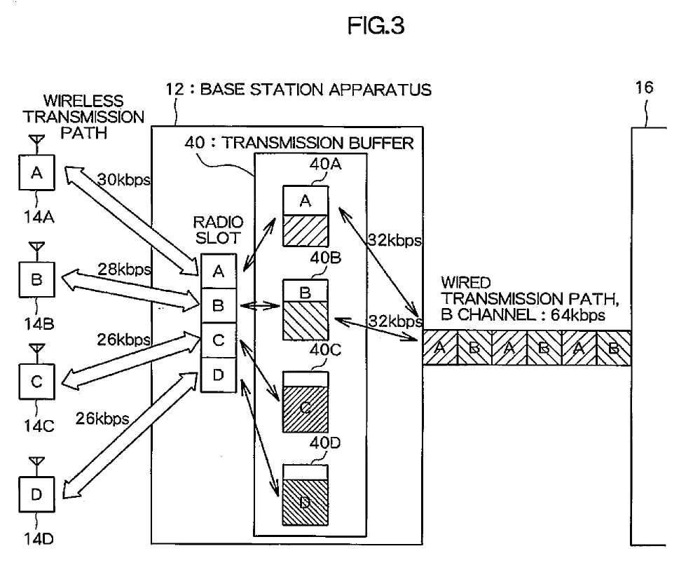

FIG. 2 is a functional block diagram of the base station apparatus 12. The base station apparatus 12, which includes a control part 20, a wireless communication part 30, transmission buffers 40, and a line interface 50, transmits/receives radio signals to/from each of the plurality of mobile station apparatuses 14, as well as transmits/receives packets to/from each of a plurality of other base station apparatuses via the line interface 50.

The control part 20 includes a transmission buffer control part 21, a timing information calculating part 22, a packet flow control part 26, and a timer control part 27, and controls the entire base station apparatus 12. The control part 20 is configured of a CPU, a memory, and the like. It should be noted that each functional block within the control part 20 is described below in detail.

The wireless communication part 30, which is provided with an antenna 32 and is connected to the line interface 50 via the transmission buffers 40, demodulates signals received by the antenna 32 from each of the mobile station apparatuses 14, and, after separating and extracting packets, outputs the extracted packets to the line interface 50. Further, the wireless communication part 30 multiplexes a plurality of packets that are input from the line interface 50 via the transmission buffers 40, for example, and then transmits the modulated signals to the respective mobile station apparatuses 14 via the antenna 32.

Each of the transmission buffers 40 is provided for each radio resource (radio slot or the like). Each of the transmission buffers 40 is connected to the wireless communication part 30, the line interface 50, and the transmission buffer control part 21. Each of the transmission buffers 40 accumulates, according to an instruction from the transmission buffer control part 21, packets directed to each of the mobile station apparatuses 14, which are input from the line interface 50, as well as outputs the accumulated packets to the wireless communication part 30. It should be noted that at least one radio resource is allocated to each of the mobile station apparatuses 12 that are involved in communications.

The line interface 50, which is connected to the packet flow control part 26 and the communication network 16 and is also connected to the wireless communication part 30 via the transmission buffers 40, outputs packets that are input from the communication network 16 to the transmission buffers 40. The line interface 50 also outputs a plurality of packets that are input from the wireless communication part 30 to the communication network 16. As described below, a flow rate of packets that are input from the communication network 16 is controlled by the packet flow control part 26 as necessary.

Next, each functional block within the control part 20 is described.

The transmission buffer control part 21, which is connected to the transmission buffers 40, the packet flow control part 26, and the timing information calculating part 22, controls input/output of packets from/to the transmission buffers 40. Specifically, in cooperation with the packet flow control part 26, the transmission buffer control part 21 causes the transmission buffers 40 to store packets that are input from the line interface 50, or outputs packets accumulated in the transmission buffers 40 to the wireless communication part 30. The transmission buffer control part 21 also outputs a data amount of packets accumulated in each of the transmission buffers 40 to the timing information calculating part 21.

The timing information calculating part 22 is connected to the transmission buffer control part 21, the packet flow control part 26, the timer control part 27, and the wireless communication part 30. Further, the timing information calculating part 22, which includes an accumulated data amount acquiring part 23, a wireless transmission rate acquiring part 24, and a transmission path reception rate acquiring part 25, calculates timing information indicating a timing when each of the transmission buffers 40 becomes empty. The timing information is such information that indicates how unlikely the transmission buffer 40 is to become empty, for example, a period of time that the transmission buffer 40 takes to become empty. In this case, the timing information is calculated based on the data amount within each of the transmission buffers 40, which is acquired by the accumulated data amount acquiring part 23, and a rate of change of that data amount. Further, the rate of change of the data amount is calculated based on a transmission rate of packets in each wireless channel, which is acquired by the wireless transmission rate acquiring part 24, and a transmission rate of packets that are directed to each of the mobile station apparatuses and are received via the line interface 50, which is acquired by the transmission path reception rate acquiring part 25. It should be noted that the timing information calculating part 22 calculates, according to an instruction from the timer control part 27, the aforementioned timing information periodically, and outputs the calculated timing information of the respective transmission buffers 40 to the packet flow control part 26.

The accumulated data amount acquiring part 23 acquires the data amount of packets accumulated in each of the transmission buffers 40 from the transmission buffer control part 21. The wireless transmission rate acquiring part 24 acquires the transmission rate of packets in each of the wireless channels from the wireless communication part 30. The transmission path reception rate acquiring part 25 acquires, from the packet flow control part 26, the transmission rate of packets directed to each of the mobile station apparatuses, which are received via the line interface 50.

The packet flow control part 26, which is connected to the transmission buffer control part 21, the timing information calculating part 22, the timer control part 27, and the line interface 50, selects at least one of the transmission buffers 40 based on the timing information of the respective transmission buffers 40, which is input periodically from the timing information calculating part 22, and controls the packet flow directed to the mobile station apparatus associated with the transmission buffer. Specifically, the packet flow control part 26 judges whether or not there is any transmission buffer 40 with the accumulated data amount decreasing based on the timing information of the respective transmission buffers 40, and when there is any, selects the transmission buffer 40 that is expected to become empty at earlier timing and then performs control of accelerating the packet flow directed to the mobile station apparatus associated with the transmission buffer. Alternatively, the packet flow control part 26 selects the transmission buffer 40 that is expected to become empty at later timing, and then performs control of limiting the packet flow directed to the mobile station apparatus associated with the transmission buffer. The judgment as to whether the timing when the transmission buffer becomes empty is later or not can be made based on, for example, whether or not a period of time that the transmission buffer takes to become empty is equal to or larger than a predetermined period of time or whether or not a period of time that the transmission buffer takes to become empty is the largest. With this configuration, the flow rate of packets into the transmission buffer 40 that is expected to become empty at earlier timing can be increased, thereby delaying the timing when the transmission buffer becomes empty.

Further, the packet flow control part 26 may be configured to cancel, when the data amount within the transmission buffer 40 subjected to the increase of the packet flow rate has become equal to or larger than a predetermined amount, a limitation on the packet flow. With this configuration, once the data amount within the transmission buffer 40 subjected to the increase of the packet flow rate has reached an adequate amount, the limitation on the packet flow is canceled and the packet flow can be restored to the former state. It should be noted that the aforementioned limitation on the packet flow and the cancellation thereof are executed by the packet flow control part 26 instructing another base station apparatus 12, which is a transmission source of the packets, to change a transmission amount of the packets or transmission intervals.

Further, with regard to the transmission buffer 40 that has a possibility of an overflow of the buffer due to a large amount of accumulated data, the packet flow control part 26 limits, as usual, the packet flow directed to the mobile station apparatus associated with the transmission buffer until the accumulated data amount of the transmission buffer becomes less than the predetermined amount, thereby preventing the overflow of the transmission buffer.

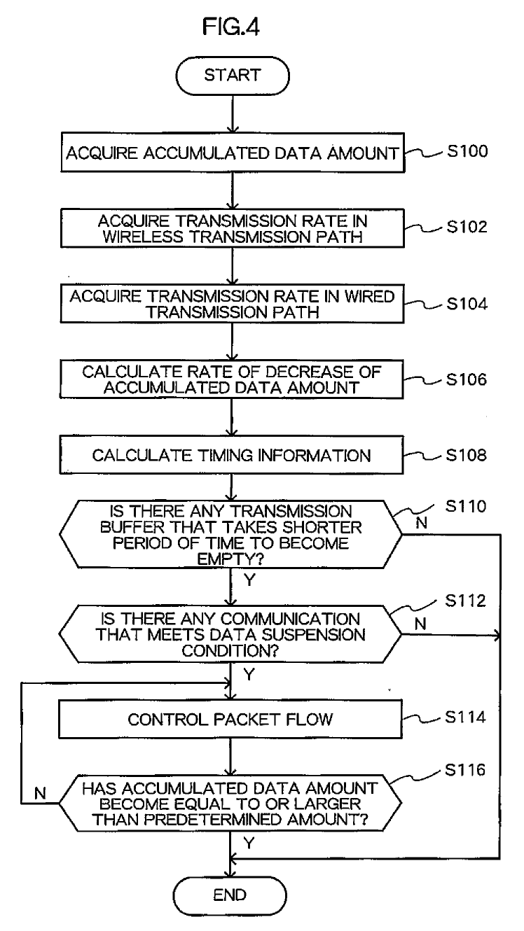

Here, referring to FIG. 8 and FIG. 3, a process concerning the aforementioned packet flow control is described specifically. The base station apparatus 12 illustrated in FIGS. 3 and 8 is connected to the communication network 16 via the wired transmission path that uses the B-channel of the integrated services digital network (ISDN) line with a transmission rate of 64 kbps, and performs packet communications based on X.25 protocol. In the wired transmission path, packets directed to the respective mobile station apparatuses 14 are each flowing at 16 kbps. Further, the base station apparatus 12 performs communications with four mobile station apparatuses 14A, 14B, 14C, and 14D via the wireless transmission paths (wireless channels) having transmission rates of 30 kbps, 28 kbps, 26 kbps, and 26 kpbs, respectively. Specifically, in the example illustrated in FIG. 8, for all the communications concerning the respective mobile station apparatuses 14, the transmission rates of the wired transmission path are below the transmission rates of the wireless transmission paths, with the data amounts within the transmission buffers 40A, 40B, 40C, and 40D decreasing at a rate of 14 kbps, 12 kbps, 10 kbps, and 10 kbps, respectively. If this state continues, the transmission buffer 40A, which has the smallest amount of accumulated data and the fastest rate of decrease of the data amount, becomes empty first, whereas the transmission buffers 40C and 40D, which have the largest amounts of accumulated data and the slowest rate of decrease of the data amount, become empty last.

In the state illustrated in FIG. 8, the timing information calculating part 22 acquires a rate of decrease of the data amount of each transmission buffer 40, which represents a difference between the transmission rate of packets in each of the wireless channels and the transmission rate of packets directed to each of the mobile station apparatuses in the wired transmission path, and then calculates a period of time that each of the transmission buffers 40 takes to become empty based on the rate of decrease of the data amount and the data amount within each of the transmission buffers 40, which is acquired by the accumulated data amount acquiring part 23. The packet flow control part 26 selects the transmission buffers 40C and 40D with the periods of time that are input from the timing information calculating part 22 equal to or larger than the predetermined period of time, and then instructs another base station apparatus 12, which is the transmission source of the packets, to limit the packet flows in the wired transmission path which are directed to the mobile station apparatuses 14C and 14D associated with the selected transmission buffers 40C and 40D. Then, as illustrated in FIG. 3, in the wired transmission path, packet transmissions directed to the mobile station apparatuses 14C and 14D are suspended, thereby allowing only packets directed to the mobile station apparatuses 14A and 14B to flow. Assuming that the packets directed to the mobile station apparatuses 14A and 14B each flow at 32 kbps in the wired transmission path, the transmission rates in the wired transmission path exceed the transmission rates in the wireless transmission paths, with the data amounts within the corresponding transmission buffers 30A and 30B increasing at rates of 2 kbps and 4 kbps, respectively. With this configuration, the accumulated data amounts of the transmission buffers 30A and 30B can be increased, thereby delaying timings when the transmission buffers become empty.

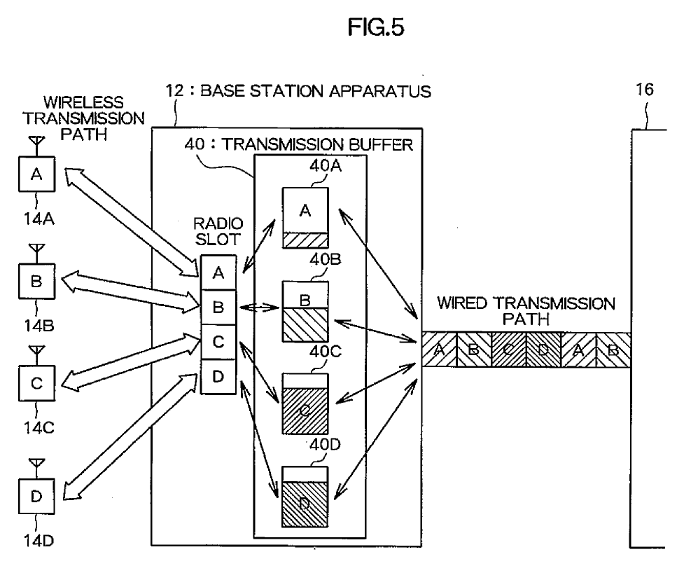

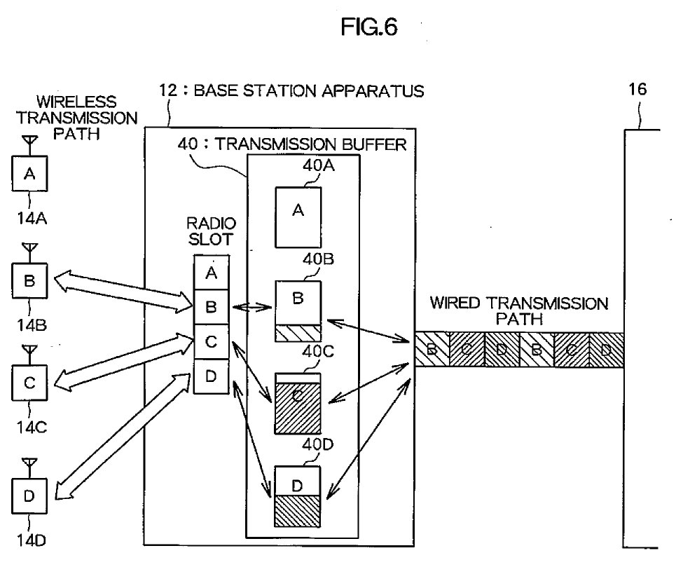

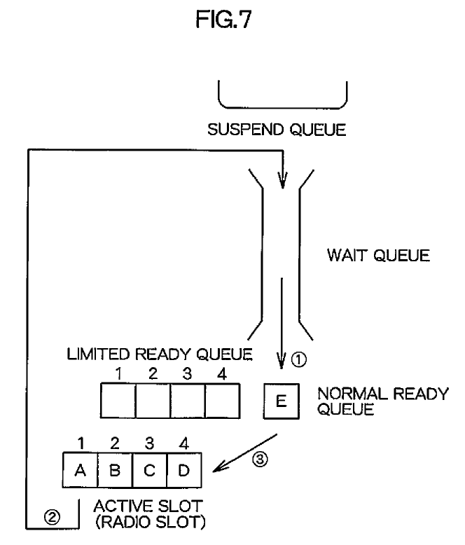

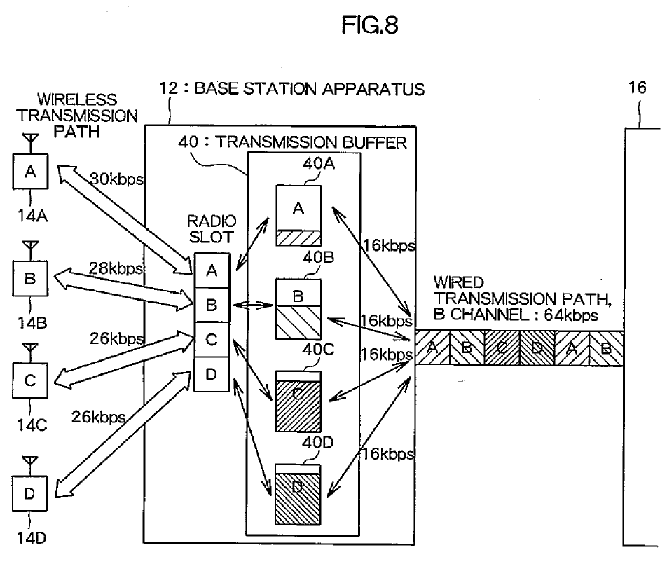

Next, a packet flow control process according to the embodiment of the present invention is described with reference to a flow chart of FIG. 4. The process illustrated in FIG. 4 is started periodically according to an instruction from the timer control part 27.

In response to the instruction from the timer control part 27, the timing information calculating part 22 calculates the timing information indicating a timing when each of the transmission buffers 40 becomes empty. Specifically, the accumulated data amount acquiring part 23 acquires the data amount of packets accumulated in each of the transmission buffers 40 from the transmission buffer control part 21 (S100). Subsequently, the wireless transmission rate acquiring part 24 acquires the transmission rate of packets in each of the wireless channels from the wireless communication part 30 (S102). Further, the transmission path reception rate acquiring part 25 acquires, from the packet flow control part 26, the transmission rate of packets directed to each of the mobile station apparatuses, which are received via the line interface 50 (S104). The timing information calculating part 22 calculates the rate of decrease of the data amount of each transmission buffer 40 based on the acquired transmission rate of packets in each of the wireless channels and the acquired transmission rate of packets directed to each of the mobile station apparatuses, which are received via the line interface 50 (S106). Then, the timing information calculating part 22 calculates a period of time (timing information) that the transmission buffer takes to become empty based on the rate of decrease of the data amount and the data amount within each of the transmission buffers 40, which is acquired by the accumulated data amount acquiring part 23 (S108).

In S110, the packet flow control part 26 judges, based on each piece of the timing information that is input from the timing information calculating part 22, whether or not there is any transmission buffer 40 that takes a shorter period of time to become empty. Then, if there is no transmission buffer 40 that takes a shorter period of time to become empty, the current process is ended, whereas if there is any, the packet flow control part 26 judges whether or not the mobile station apparatus associated with the transmission buffer meets a data suspension condition (S112). Here, the data suspension condition refers to a condition for the mobile station apparatus to transfer a communication right (allocation of radio resource) to another mobile station apparatus when there is no data to be transmitted left, that is, when the transmission buffer has become empty. In S112, when the mobile station apparatus associated with the transmission buffer 40 that is expected to become empty in a shorter period of time does not meet the aforementioned data suspension condition, there is no fear of allocation of the radio resource being changed even if the transmission buffer has become empty, and hence the current process is ended. On the other hand, when the mobile station apparatus meets the data suspension condition, the process proceeds to S114 in order to prevent allocation change of the radio resource caused by the transmission buffer becoming empty.

In S114, the packet flow control part 26 selects the transmission buffer 40 that takes a longer period of time to become empty, that is, the transmission buffer 40 for which a period of time to become empty is equal to or larger than the predetermined period of time, based on the timing information that is input from the timing information calculating part 22, and then suspends the packet flow directed to the mobile station apparatus associated with the transmission buffer in the wired transmission path. The suspension of the packet flow is maintained until the data amount within the transmission buffer that has been determined, in S110, to take a shorter period of time to become empty becomes equal to or larger than the predetermined amount (S114 and S116). In S116, if the data amount within the transmission buffer has become equal to or larger than the predetermined amount, the current process is ended.

According to the base station apparatus and the method for controlling the base station apparatus as described above, it is possible to prevent a transmission buffer from becoming empty during communication, thereby reducing the frequency of allocation change of a radio resource. Accordingly, the throughput of data transmission can be improved.

It should be noted that the present invention is not limited to the aforementioned embodiment. For example, the present invention is, regardless of system of multiple access, applicable to any kind of base station apparatus and wireless communication system that includes a plurality of radio resources and a plurality of transmission buffers associated therewith. The present invention is also applicable to a case where the base station apparatuses are connected to the communication network via the wireless transmission path.

1. A base station apparatus that is configured to: receive, in communicating with each of a plurality of mobile station apparatuses via a wireless channel, packets directed to each of the mobile station apparatuses, which are transmitted from another base station apparatus connected via a transmission path; accumulate the received packets in each transmission buffer in association with each of the mobile station apparatuses; and sequentially transmit the packets accumulated in the each transmission buffer to each of the mobile station apparatuses, comprising:
timing information calculating means for calculating timing information indicating a timing when the each transmission buffer becomes empty; and
packet flow control means for selecting at least one transmission buffer based on each piece of the timing information calculated by the timing information calculating means, and controlling, in the transmission path, a packet flow directed to the mobile station apparatus associated with the selected transmission buffer.

2. A base station apparatus according to claim 1, wherein the timing information calculating means comprises accumulated data amount acquiring means for acquiring, for each of the mobile station apparatuses, a data amount of the packets accumulated in the each transmission buffer, and calculates the timing information based on the data amount acquired by the accumulated data amount acquiring means and a rate of change of the data amount.

3. A base station apparatus according to claim 2, wherein:
the timing information calculating means further comprises:
wireless transmission rate acquiring means for acquiring a transmission rate of the packets in the wireless channel with respect to each of the mobile station apparatuses; and
transmission path reception rate acquiring means for acquiring a transmission rate of the packets in the transmission path with respect to each of the mobile station apparatuses; and
the rate of change of the data amount is calculated based on the transmission rate acquired by the wireless transmission rate acquiring means and the transmission rate acquired by the transmission path reception rate acquiring means.

4. A base station apparatus according to claim 2, wherein the packet flow control means selects at least one transmission buffer with the timing information equal to or larger than a predetermined value, and limits, in the transmission path, the packet flow directed to the mobile station apparatus associated with the selected transmission buffer.

5. A base station apparatus according to claim 2, wherein the packet flow control means selects the transmission buffer with the timing information indicating a largest value, and limits, in the transmission path, the packet flow directed to the mobile station apparatus associated with the selected transmission buffer.

6. A base station apparatus according to claim 4 or 5, wherein the packet flow control means cancels a limitation on the packet flow when the data amount with respect to at least one transmission buffer other than the selected transmission buffer, which is acquired by the accumulated data amount acquiring means, has become equal to or larger than a predetermined amount.

7. A method for controlling a base station apparatus that is configured to: receive, in communicating with each of a plurality of mobile station apparatuses via a wireless channel, packets directed to each of the mobile station apparatuses, which are transmitted from another base station apparatus connected via a transmission path; accumulate the received packets in each transmission buffer in association with each of the mobile station apparatuses; and sequentially transmit the packets accumulated in the each transmission buffer to each of the mobile station apparatuses, comprising:
a timing information calculating step of calculating timing information indicating a timing when the each transmission buffer becomes empty; and
a packet flow control step of selecting at least one transmission buffer based on each piece of the timing information calculated in the timing information calculating step, and controlling, in the transmission path, a packet flow directed to the mobile station apparatus associated with the selected transmission buffer.
